(19) United States
(12) Patent Application Publication
(10) Pub. No.: US 2015/0129702 A1
(43) Pub. Date: May 14, 2015

(54) RETRACTABLE EAR BUD CASE

(71) Applicant: Nytro Labs, LLC, Wheaton, IL (US)

(72) Inventors: Kevin Brennan, Wheaton, IL (US); Jon Godston, Chicago, IL (US); McKay R. Johnson, Chicago, IL (US); Michael Prstojevich, Portland, OR (US)

(21) Appl. No.: 14/538,657

(22) Filed: Nov. 11, 2014

Related U.S. Application Data
(60) Provisional application No. 61/903,263, filed on Nov. 12, 2013.

(51) Int. Cl. H04R 1/10; B65H 75/44; B65H 75/40

(52) U.S. Cl. CPC H04R 1/1033; B65H 75/406; B65H 75/4471
USPC 242/388.6

(57) ABSTRACT

A retractable ear bud case having a separate plug wire and ear bud wire is disclosed. Each wire is wound about a separate spool assembly. The spool assemblies provide for electrical connection between the wires, even as they rotate about one another in order to allow for independent payout of either wire. A lock assembly provides for smooth, controlled noiseless payout and immediate locking once a desired distance is reached. Each wire is automatically retracted upon release of the locking assembly. The case may provide housings for ear buds, a male plug, and a microphone, all of which may be components of the invention according to certain embodiments.

### CROSS-REFERENCE TO RELATED APPLICATIONS

This non-provisional patent application claims priority to U.S. Provisional Patent App. No. 61/903,263 filed on Nov. 12, 2013. The provisional application is incorporated herein by reference in its entirety.

### TECHNICAL FIELD

The present invention relates to audio speaker devices, and storage cases for such devices. More specifically, the invention is directed to ear bud and in-ear headphone assemblies, particularly those that recoil or retract into a portable carrying case comprising part of the assembly.

### BACKGROUND

With the proliferation of mobile phones and consumer electronics with audio capability, a variety of variations to the traditional wired headphones have been attempted. A problem with such headphones are the lengthy wires that connect the speakers (e.g., ear buds) to the mobile device playing the audio, be it recorded music, a cellular phone call, etc. Usually this device is carried in a pocket at the user's waist, or carried in hand, requiring the wire to be at least a couple feet in length. When not in use, the wire becomes tangled when jammed into a pocket or bag, causing users to waste time untangling them when ready for use again.

To help solve this problem, solutions have evolved that provide a housing or case for the wire, with an internal spool used to coil the wire when not in use. For example, U.S. Pat. No. 7,614,578 to Ito (“Ito”) describes a headphone with a wire take-up device that allows a connection wire to be pulled out of a housing so as to insert the plug at the end of a wire into the jack of an audio-playing device. The headphone is placed directly over a user's ear with ear pads 22 resting against the user and loudspeaker 21 producing the volume. The input wire 9 is wrapped around a reel 1 as shown in FIG. 2. The wire is pulled out, but locks in place when ratchet wheel 5 comes into contact with an engaging pawl 7a. When the pawl is released, the reel spins to collect the wire back into the headphone. This results in a complex, bulky object instead of a more commonly excepted in-ear or on-ear bud. Also, though the design uses buffers to prevent the “harsh clicking sound” produced by the ratchet hitting against the pawl when the wire is pulled out, some unpleasant noise and feel still will exist.

U.S. Pat. No. 8,290,547 to Cataldo, et al (“Cataldo”) provides a different solution where the excess wire is stored with the audio device. Cataldo teaches a wire housing and a separate device housing. The device housing covers over the audio-playing device and has a separate wire with two male ends—one for insertion into the device and one for insertion into a female port of the wire housing. The female port is electrically connected to a reel for an ear bud wire, which is wound around the reel. The ear buds are left floating outside the wire housing. The flanges of the reel have teeth and serve as a gear that is rotated by a driven power gear. This solution would also produce noise, and is also rather bulky and requires a case that matches a particular audio device.

What is needed is an audio wire housing that can be used universally with different audio devices, can be comfortably positioned on a user's clothing or a convenient place nearby, and can feed and retract headphone wires smoothly, under control, and without producing a clicking noise produced by traditional ratchet-based systems.

### SUMMARY OF THE INVENTION

According to a particular embodiment, the present invention is an ear bud case assembly that comprises both an earbud wire and a plug wire. Each wire is wound and stored about a separate reel assembly, which are in electrical contact with one another even as they may rotate relative to one another. Each reel assembly is held in place by a lock assembly that utilizes one-way bearings for allowing the wires to be smoothly extended, but prevents retraction until the bearings are released from the reel flanges.

The invention provides a case that allows for separate, independent withdrawal of a first wire with a plug end for connection to an audio-playing device and a second wire with ear buds or other headphones on the end for placement in or on a user's ears. The case itself can then be placed in a pocket, clipped on a shirt, or placed anywhere in between the playing device and the headphones. For example, a user could be operating the device in their hand with the ear buds in their ears, while the case is managing the length of the separate wires from a position on the user's belt. A release button then seamlessly retracts both wires into the case, which, in accordance with the illustrated embodiment, provides exterior housings for the ear buds and the plug, as well as a microphone positioned along the ear bud wire for collecting audio and allowing the user to operate a phone using the invention.

While certain features and embodiments are referenced above, these and other features and embodiments of the present invention will be, or will become, apparent to one having ordinary skill in the art upon examination of the following figures and detailed description. It is intended that all such additional embodiments and features included within this description, be within the scope of the present invention, and be protected by the accompanying claims.

### BRIEF DESCRIPTION OF THE DRAWINGS

The present invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is an isometric view of the front of a retractable ear bud case according to an illustrated embodiment of the present invention.

FIG. 2 is an isometric view of the rear of the case shown in FIG. 1.

FIG. 3 is a top view of the case shown in FIG. 1.

FIG. 4 is a bottom of the case shown in FIG. 1.

FIG. 5 is a side view of the case shown in FIG. 1.

FIG. 6 is a perspective view of the interior of the case shown in FIG. 1, illustrating the inside of the upper housing, and certain components housed therein.

FIG. 7 is a different perspective view of the interior of the case shown in FIG. 1, illustrating the inside of the lower housing, and certain components housed therein.

FIG. 8 is a perspective view of the spool assemblies and lock assembly of the case shown in FIG. 1.

FIG. 9 is an exploded view of the lower housing, and the components shown in FIG. 7.

FIG. 10 is an exploded view of a contact disk and certain electrical spring contacts.

FIG. 11 is an exploded view of the upper housing, and certain of the components shown in FIG. 6.

FIG. 12 is an exploded view of the spool assembly shown in FIG. 11.

FIG. 13 is a partially exploded view showing the assembled components of FIG. 11 with the lock assembly added in exploded view.

FIG. 14 is a partially exploded view of the lock assembly shown in FIG. 11.

FIG. 15 is a close-up isometric view of the lock assembly shown in FIG. 14.

FIG. 16 is an exploded view of one of the 1-way bearing of the lock assembly shown in FIG. 15.

FIG. 17 is an exploded view of the retractable ear bud case of FIG. 1, showing the upper and lower housings coming together.

### DETAILED DESCRIPTION

The description that follows describes, illustrates and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

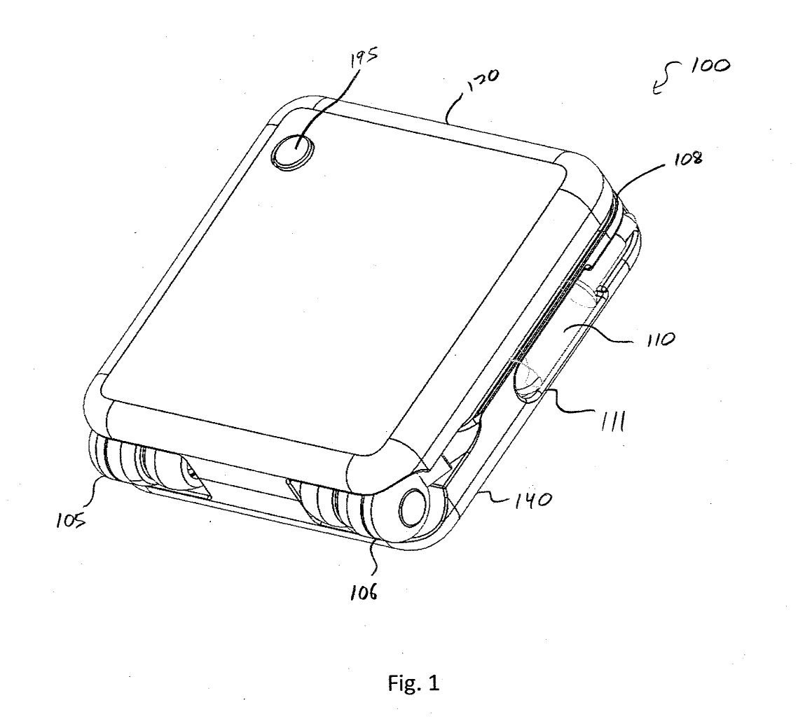

FIG. 1 shows an isometric view of the exterior of an ear bud case 100 according to a particular embodiment. As used herein the term “ear bud” is intended to broadly refer to any wired on-ear or in-ear headphones intended for placement in the auditory canals of a user's ear or attachment to a user's ear in a place close enough to the auditory canal for proper sound reception. It will be understood that, for example, the ear buds 105 and 106 could be replaced in other embodiments with different styles of miniature on-ear or in-ear speakers for use in local audio transmission. Such different styles could be accommodated by differently shaped cavities formed in the exterior of the case with modifications to the illustrated embodiment that would be well within the reach of one skilled in the art, upon a review of this disclosure. Moreover, it will be understood that the shape of the case need not be square, but rather could be of any shape large enough to accommodate the internal components described below.

As illustrated, the case 100 comprises an upper housing 120 and a lower housing 140 that come together along a central seam to form an enclosure for storing excess wire. The case comprises two separate wires—one terminating in a male plug 110 and the other terminating in left and right ear bud assemblies 105 and 106. The former is referred to herein as the plug wire 113, and is not shown in FIG. 1 because it is fully recoiled. The latter is referred to as the ear bud wire 108, which is shown wrapped around the exterior sides of fully assembled case 100.

It will be understood that ear bud wire 108 and plug wire 113 may each comprise multiple internal wires for carrying different currents. For example, the illustrated embodiment envisions a ground wire, left and right audio wires, and a microphone wire. These wires are collectively wrapped in a traditional liner material, such that they appear to be single wires. As will be seen, the other ends of each of the plug wire 113 and the ear bud wire 108 are connected to spool assemblies within the case 100 such that they are in electrical contact via the spool assemblies.

Also apparent from FIG. 1 are the cavities formed cooperatively by the exterior of the upper and lower housings 120 and 140. These include the bud cavities 122/142, and the microphone cavity 121/141. There is also a plug cavity 111 formed exclusively in the lower housing 140 in the illustrated embodiment. In this case, with the plug 110 in its cavity 111, the plug wire 113 is completely within the case. Each cavity provides slight overlapping edges to help secure the components in place when snapped in. These cavities provide a sleek package such that all components of the case fit snugly in place and do not dangle loose when the wires are fully retracted. This, in turn, prevents the wires from being inadvertently paid out when not desired. It also helps protect the more sensitive ear buds and plug connection from potential damage. In addition, the portion of the ear bud wire 108 that extends out of the case 100 (only an amount long enough to provide for external packaging of the microphone 115), is seated into a groove formed by the parting line between the upper and lower housings 120/140, and, thus, is also protected. The wires may be uncoiled (paid out) simply by releasing the plug 110 and/or ear buds 105/106 and pulling gently to distribute the wires. In order to collect them again, the release 195 is slid in a manner so as to release a locking assembly inside the case.

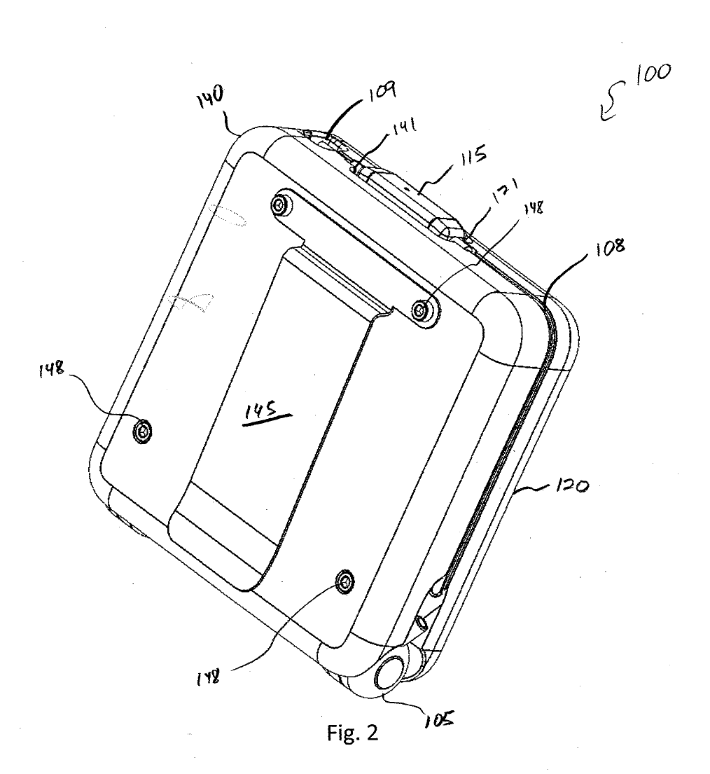

FIG. 2 shows a rear isometric view of case 100. This view reveals the microphone 115 resting inside the cavity formed by microphone cavities 121/141. As seen, ear bud wire 108 extends around the exterior of the case 100, through the microphone 115, and in to ear bud wire hole 109 in order to reach its wound spool inside the case. Though not shown, it will be understood that the right branch of the ear bud wire 108 comes in to the hole 109 from the other side, at which point the right and left branches fuse into a single wire at some point before reaching the other terminus at or near the spindle of the ear bud wire spool assembly 160. As shown in this view, four fasteners 148 are used to attach the upper and lower housings 120/140 together. Two of the fasteners are also used to attach a clasp 145 that can be used to clip the case 100 to various items of clothing, for example.

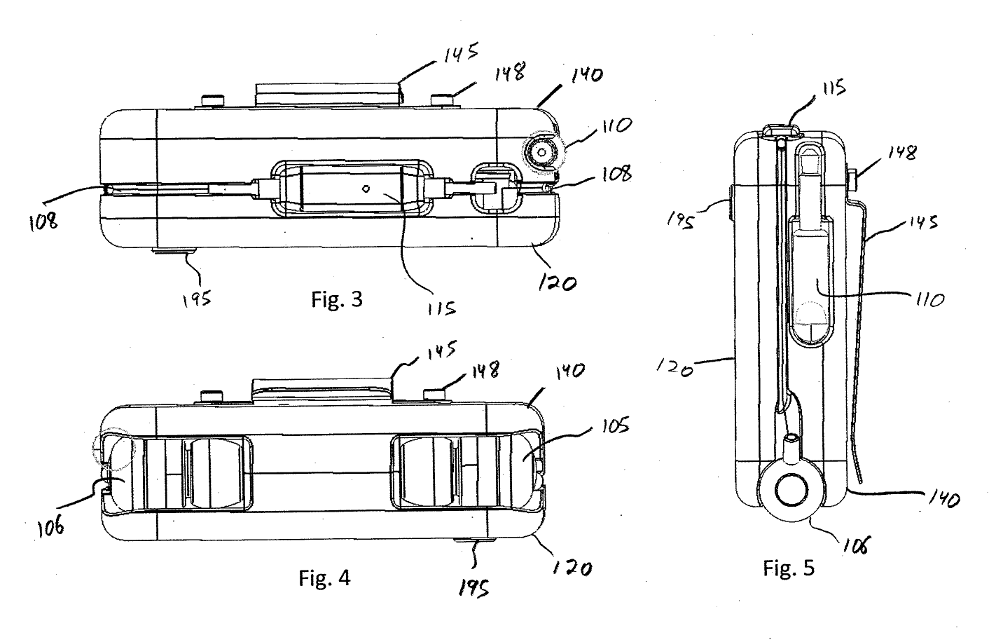

FIGS. 3-5 show additional views of the exterior of the fully assembled case 100. The top view of FIG. 3 shows the microphone 115 in its cavity, and the ear bud wire 108 extending out of the hole 109 in either direction. The wires extend around to the bottom of the case (FIG. 4) where they terminate at the ear bud assemblies 105/106. The side view of FIG. 5 shows each of the microphone 115, the right ear bud 106 and the plug 110 in their respective cavities formed by the upper and lower housings 120 and 140.

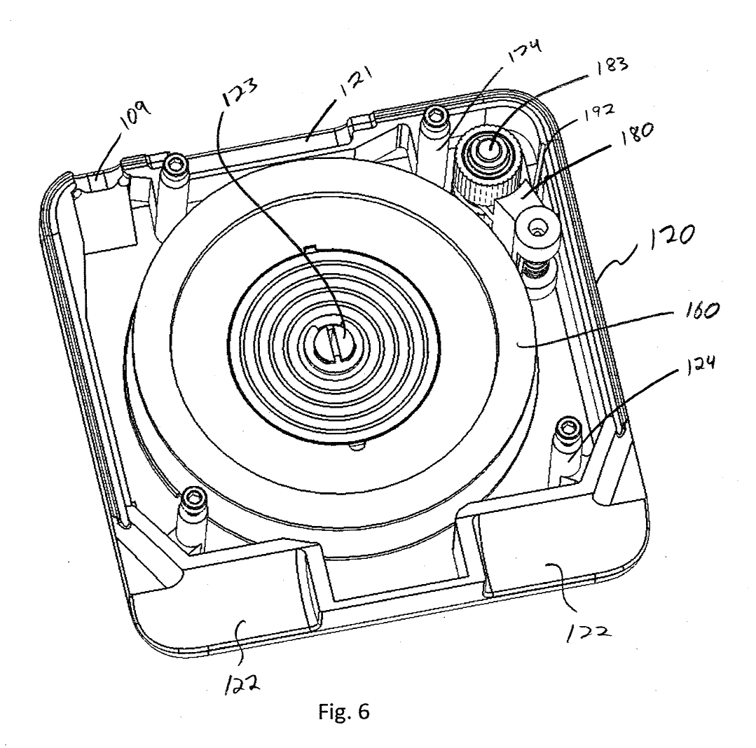

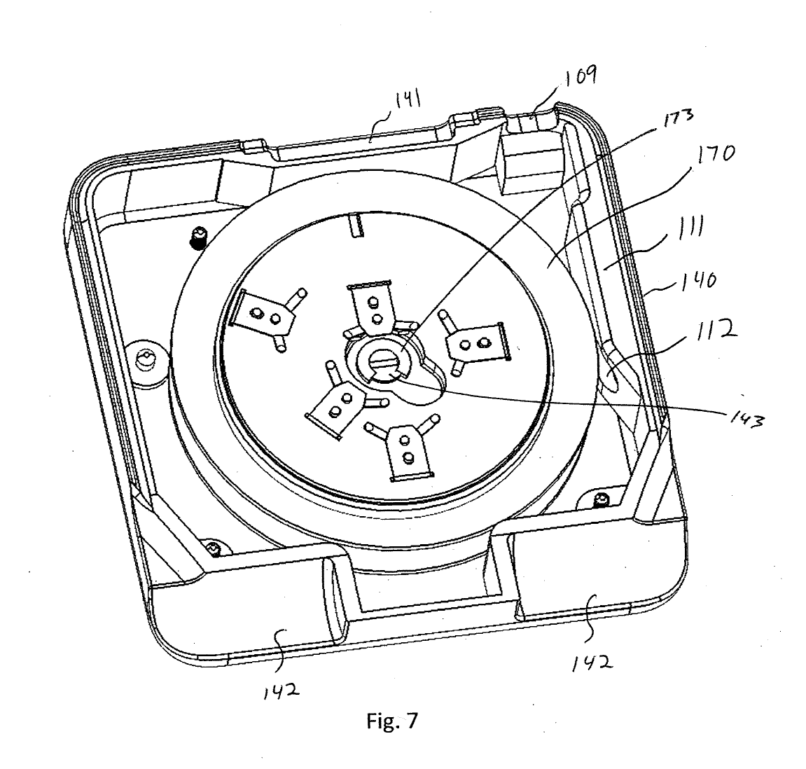

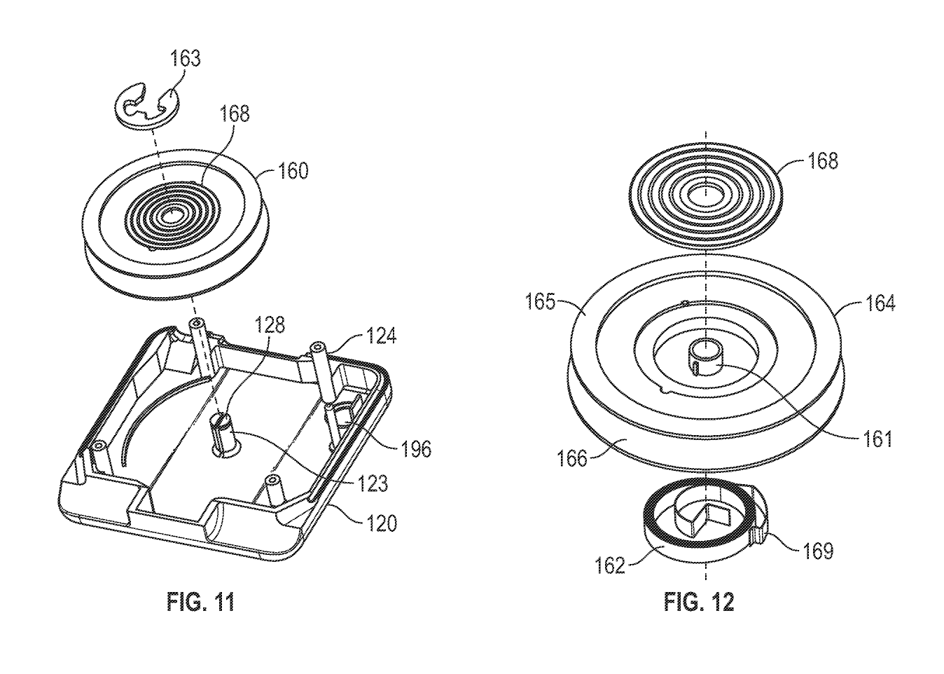

FIG. 6 begins to reveal the inner workings of the case 100. In this view, the lower housing 140 and plug wire spool assembly have been removed. The ear bud wire 108, ear buds 105/106 and microphone 115 have also been removed to better show the bud cavities 122, and microphone cavity 121 formed in the housing. As shown, the upper housing 120 comprises four fastener posts 124 for receiving the fasteners 148 used to hold the housings 120/140 together. It will be understood that there could be more or less of these posts, and they could be positioned differently in other embodiments. However, as shown, they are positioned to provide packaging space for an ear bud wire spool assembly 160, which is best illustrated in FIGS. 11 and 12. The assembly 160 is positioned over a centering post 123 formed in the upper housing (see FIG. 11) about which it rotates.

Turning to FIG. 11, an inner view of the upper housing 120 is shown, with the ear bud wire spool assembly 160 pulled away. The spool seats over the post 123 and is kept from coming off the post by a clamp 163. The components of the ear bud wire spool assembly 160 are shown in FIG. 12. The primary component is the ear bud reel 164, which consists of upper and lower flanges 165/166, spaced apart by a spindle 161. The lower flange 166 accommodates a coil spring 162, having inner end 167 and outer end 169. The inner end is fed through a slot 128 in centering post 123, such that it is fixed to the non-rotating upper housing 120. The outer end 169 of the coil spring 162 is fixed to the lower flange 166, such that it rotates with the ear bud reel assembly 164, for example, as the ear bud wire 108 is pulled out of the case 100. When a lock is released, as discussed below, the then-wound coil spring 162 causes the reel assembly 164 to spin back to its nominal position, thus winding the ear bud wire 108 back into the case.

On the other side of the ear bud assembly 164 is a circular printed circuit board (PCB) 168. The PCB fits into the upper flange 165 as shown in the assembled view of FIG. 11. As illustrated, the PCB 168 comprises five separate rings, corresponding to five separate electrical connections. As discussed below, these are: left ear bud, right ear bud, ear bud ground, microphone, and microphone ground. It will be understood that some embodiments may have fewer connection points, for example, if there is no microphone in a particular option. However, the dual ground architecture of the illustrated embodiment provides for superior sound quality. The ear bud wire 108 inner terminus (not shown) is broken into the interior component wires as discussed above, and connected to one of the five ring connections on the PCB 168. As will become clear in association with the below explanation of FIGS. 7, 9 and 10, each ring of the PCB concentrically aligns with an electrical spring contact connected to one of the internal wires of the plug wire 113. Thus, as the PCB rotates relative to the spring contacts, or the spring contacts rotate as the PCB is fixed, electrical connection between the plug wire 113 and the ear bud wire 108 is maintained.

FIG. 7 illustrates the inside of the lower housing 140, and the plug wire spool assembly 170 housed therein. Similar to the manner that the ear bud wire spool assembly 160 is fixed to the upper housing, the plug wire spool assembly 170 is seated over a centering post 143 formed in the lower housing, and held in place with a clamp 173. This view of the lower housing 140 illustrates the microphone cavity 141, the ear bud cavities 142, and shows the plug cavity 111 from the inside. Also shown is the plug wire hole 112 that allows the plug wire 113 (not shown) access to the plug wire spool assembly 170 about which it is wound.

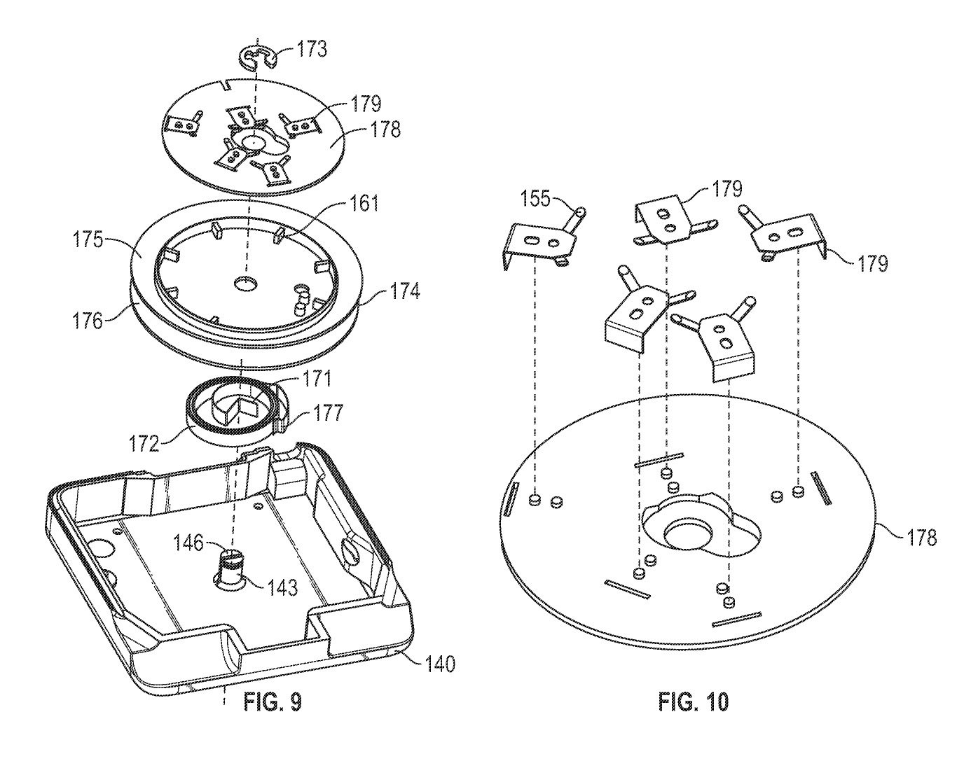

Turning to FIG. 9, the plug wire spool assembly 170 components are shown in exploded view. Like upper housing centering post 123, lower housing centering post 143 features a slot 146 used to constrain the inner end 171 of coil spring 172, while the outer end 177 of the coil spring 172 is fixed to the lower flange 176 of the plug reel assembly 174. Thus, as the plug wire 113 is paid out of the plug wire hole 112, the coil spring 172 is wound up. When a lock is released (described below), the coil unwinds to its nominal position, thereby causing the plug wire 113 to retract into the case 100.

The plug reel assembly 174 is comprised of a lower flange 176, and upper flange 175, and a connecting spindle (not shown) about which the plug wire 113 is wrapped. Seated against the exterior of the upper flange 174 is a contact disk 178. The contact disk is made of a non-conductive material so as to isolate the spring contacts 179 from one another. It will be understood that the geometry of the spring contacts 179 and disk 178 could vary without departing from the invention. Indeed, in some embodiments, the spring contacts 179 could be staked directly to the plug reel assembly 174, for example. However, in the illustrated embodiment, the contact disk 178 is offset from the upper flange 175 by a series of ribs 161, so as to create space to connect the internal wires of plug wire 113 to the individual spring contacts 179 protruding through the contact disk 178. Also as illustrated, each spring contact 179 has one or more flexible contact wings 155 designed to provide resilient and constant contact with a concentric ring of the PCB 168 which rotates against them. In some embodiments, a molybdenum coating may be applied to the PCB 168 to help increase the conductivity to the spring contacts 179, while decreasing the friction to reduce the amount of drag imposed on the torque provided by the coil springs 162/172, and to reduce the potential for wear-down and failed electrical connection over time.

Returning to FIG. 6, in the upper right corner, there is shown a lock assembly 180. Unlike prior art systems that use a rotating arm that clicks against a ratchet wheel such as Ito, the present invention utilizes the lock assembly 180 for this purpose. The lock assembly 180 is packaged within the upper housing and functions to hold the respective plug wire and ear bud wire spool assemblies 170/160 in place by counteracting the coil springs 172/162 that would otherwise operate to pull the wires back into the case 100. The lock assembly 180 remains in position as the spools rotate, helping to control and smooth their movement. This is facilitated by a unique and novel use of one-way bearings referred to commonly as “one-way needle bearings.” A needle bearing is a particular type of roller bearing that features an outer (and typically fixed) bearing cylinder around an inner (and typically rotating) bearing cage. The bearing cage has a series of “needles” that roll against the inner surface of the bearing cylinder, allowing the bearing cage to rotate inside the bearing cylinder. In some cases, the needles are only allowed to roll in one direction, causing the bearing assembly to be “one-way”. Such bearings are often used in fishing reels.

In the present invention, one-way needle bearings have been harnessed such that the bearing cage 186 is axially fixed relative to the pawl 182 while the bearing cylinder 187 rotates in one direction around the fixed bearing cage 186. As discussed below, this, in turn, allows the spool against which the bearing assembly 185 is engaged to turn in one direction only, until the lock assembly is disengaged by pulling the bearing assembly 185 away from the spool.

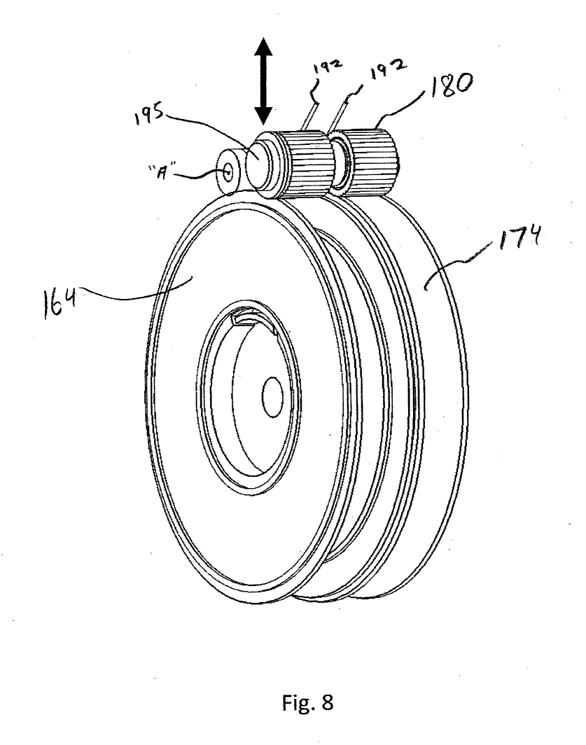

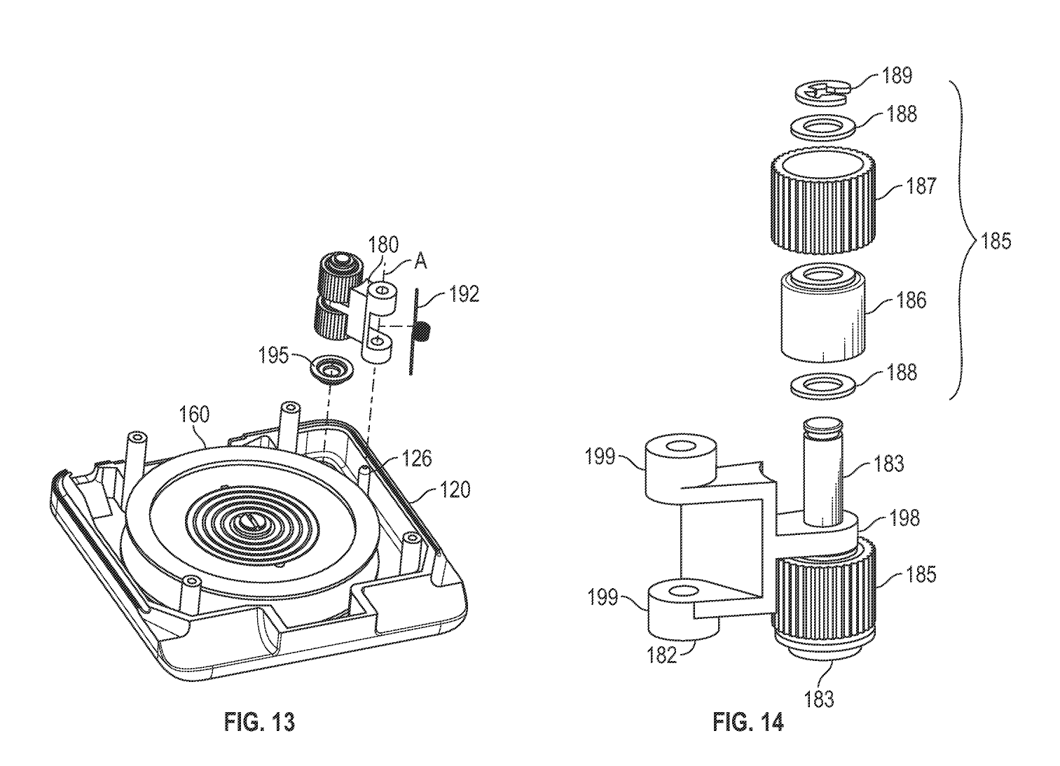

FIG. 8 shows an isometric view of the ear bud reel assembly 164 and the plug reel assembly 174 in assembled positions, such that they would rotate about a common center of axis (e.g., on the centering posts 123/143 of the upper and lower housings 120/140), while remaining parallel to one another. This, again, allows the spring contacts 179 to remain in contact with the proper concentric ring of the PCB 168 as the reel assemblies rotate. Positioned at the outer edge of the flanges of the reel assemblies is the lock assembly 180. The lock assembly 180 rotates about an axis designated “A” and shown in both FIG. 8 and FIG. 13. At the center of point “A” is the lock assembly post 126 shown in FIG. 13. The rotation of the lock assembly about axis “A” is controlled by one or more torsion springs 192. As explained further below, the torsion spring presses off of the inner wall of the upper or lower housings 120/140 in order to press the bearing assemblies 185 against the outer edge of the reel flanges. In one direction (the wire payout direction), the bearing assemblies 185 will rotate as the reel assemblies rotate.

However, as the coil springs 162/172 work to turn the reel assemblies back to their nominal state (thereby recoiling the wires), the bearing assemblies 185 will not rotate (because they are one-way), causing sufficient friction resistance to counteract the effort of the coil springs. Only when the torsion springs 192 are overcome by forcing the lock assembly 180 to rotate about the axis “A” in the direction away from the reel flanges can the coil springs do their work to recoil the wires. This is done when a user slides the release 195 to manually overcome the torsions springs 192. Note that this sliding movement only needs to be a few millimeters, thus the opening 196 for the release 195 in the upper housing 120 (see FIG. 11) need only be slightly oblong to allow the release 195 to be pushed toward the upper corner of the housing sufficiently to release the lock assembly 180.

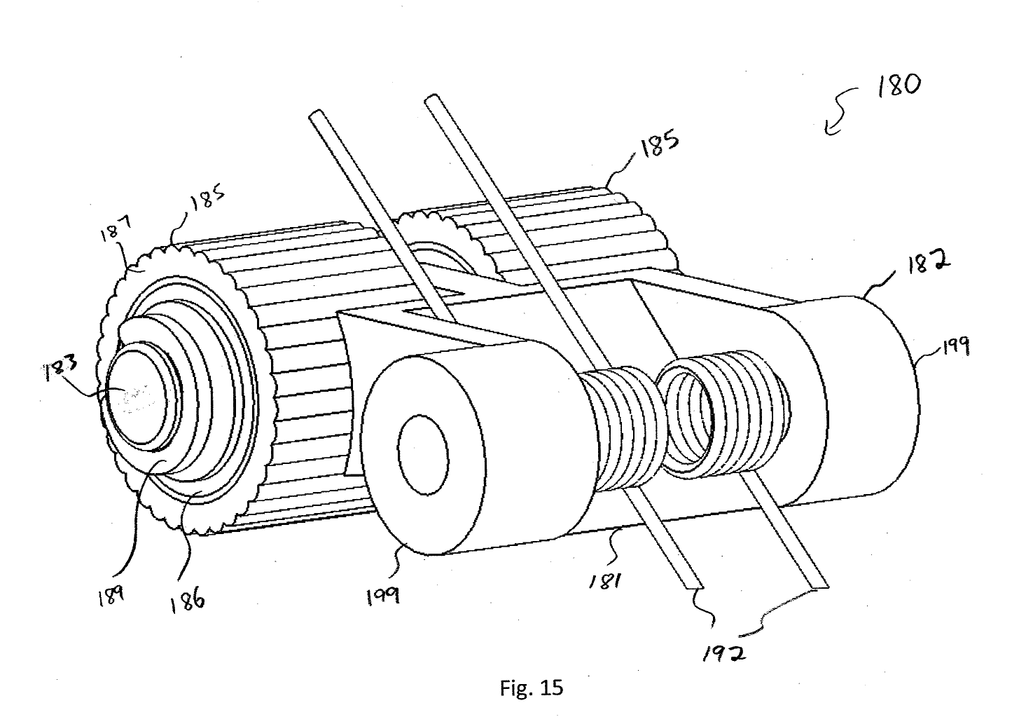

FIGS. 13-15 show the lock assembly 180 in more detail. As shown, the lock assembly 180 comprises a pawl 182 featuring two bearing posts 183 extending in either direction from a lever arm 198 attached to a first side of the main body of the pawl. On the opposite side of the pawl 182 main body are two parallel extensions 199 containing aligned holes for placement over the lock assembly post 126 (see FIG. 13). One or more torsion springs 192 are placed in between the two extensions 199 in a manner such that the spring wraps around the lock assembly post 123, holding the springs in position. As shown best in FIG. 15, a first arm of each torsion spring is loaded against a spring stop 181 provided by the carve out of the main body of the pawl 182 between the two extensions 199. The second arm of each torsion spring is loaded against the inner edge of the upper (and/or lower) housing 120, as best shown in FIG. 6. Thus, the always-loaded torsion springs are working to rotate the bearing posts 183 down toward the reel assemblies 164/174. This work is only overcome when a user further increases the load on the torsion springs 192 by sliding the release 195 to move the bearing posts 183 (and, hence, the bearing assemblies 185) off of the reel assemblies 164/174.

The lock assembly 180 comprises two bearing assemblies 185, each pressed over one of the two bearing posts 183. As shown in FIG. 14, each bearing assembly 185 comprises a one-way bearing 186, a grip cover 187, two washers 188 and a clamp 189. The grip 187 is made of a high-friction, resilient material, such as a high-durometer rubber or synthetic elastomer. The less “play” the grip has, the more “immediate” the stop will be when a user releases the plug or ear bud wire upon pulling it out of the case 100. An adhesive coating may be applied to the grip to increase its coefficient of friction. The grip 187 is pulled over the exterior of the one way bearing 186 and is fixed thereto with a permanent or semi-permanent adhesive.

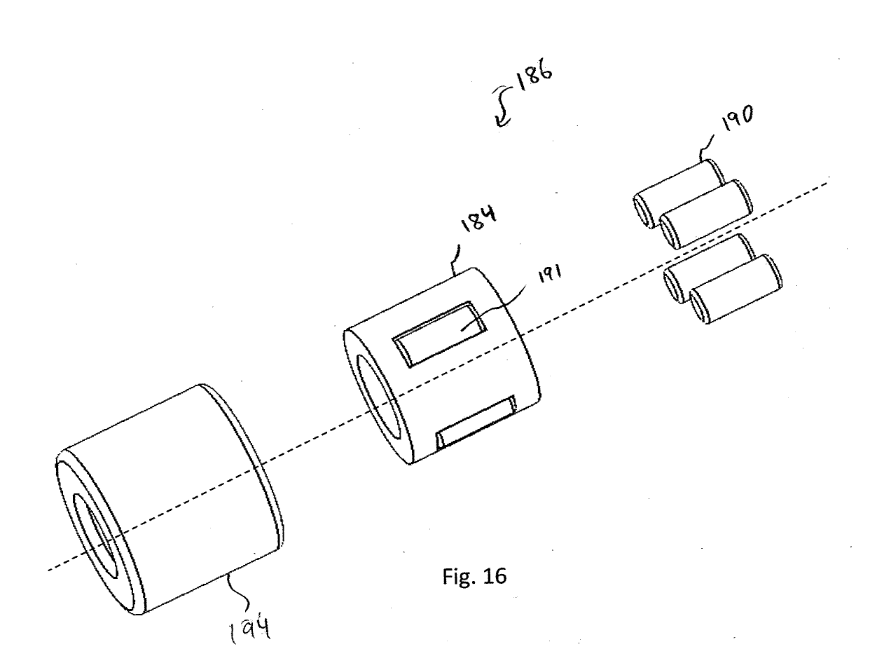

As shown in FIG. 16, each one way bearing 186 is further comprised of a bearing cage 194, a bearing cylinder 184, and a series of bearing rollers (or “needles”) 190. These bearing rollers are permanently placed in roller housings 191 of the bearing cylinder, protruding slightly outward of the circumference thereof so as to maintain a constant spacing between the bearing cylinder 184 and the bearing cage 194 as the cylinder 184 is pressed into and rotates about the inside of the cage 194. In this case, the needles are only allowed to rotate in one direction due to the internal geometry of the bearing cage 194, which incorporates a series of stops (not shown) to prevent reverse rotation. It will be understood that there are a number of one-way bearing designs available within the prior art, and that the scope of the present invention is not limited to any particular such bearing, so long as the bearing selected functions to allow rotation of the reel assemblies 164/174 in the payout direction while preventing the reel assemblies from recoiling by providing pressure and friction along their outer diameters.

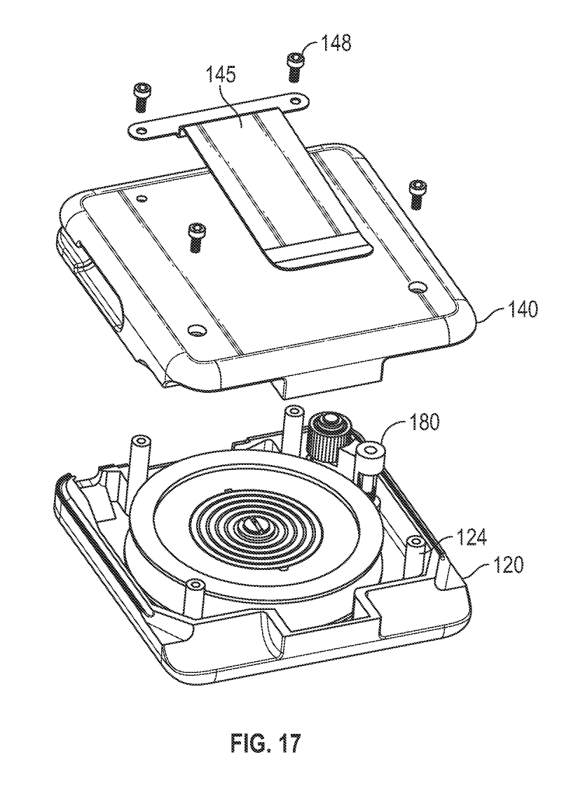

As shown in FIG. 17, once the earbud wire spool assembly 160 is positioned over the centering post 123 of the upper housing 120, the locking assembly 180 is installed over the lock assembly post 126 of the upper housing 120 such that the torsion springs 192 are pre-loaded, and the plug wire spool assembly 170 is positioned over the centering post 143 of the lower assembly 140, the upper housing 120 and lower housing 140 may be fastened together to complete the assembly of the case 100. Obviously the ear bud wire 108 and the plug wire 113 will need to be fed through their respective holes 109 and 112 prior to connecting the upper and lower housings.

The resulting product is an integrated case 100 that comprises both a plug wire 113 and an ear bud wire 108 that maintain a permanent electrical connection, but that may be independently pulled out to different lengths from the case. A single release causes both wires to be retracted back into the case. The case can, thus, be positioned at any third point between the audio playing device and the user's ears, can be universally used with any device having an audio port for a standard audio plug, provides for smooth, quiet payout and recoil, and keeps wiring in a compact, arranged format when not in use.

It will be understood by those skilled in the art that various changes may be made and equivalents may be substituted without departing from the scope of the novel and non-obvious techniques disclosed in this application. For example, the shape of the case could be round, rectangular, triangular, or any other shape so long as the two reel assemblies can be rotatably packaged parallel to one another in a manner that the lock assembly can function. The upper and lower housings could be replaced by a single, deeper housing and a cover plate, such that both reel assemblies fit into the same housing. The cavities for the microphone, ear buds and plug could be positioned at different locations along the perimeter/exterior of the case, or the components could even be drawn into the case. Some embodiments may not have microphones, or may have other formats of ear phones or ear buds. Other materials and geometries could be used to provide a friction lock along the outer circumference of the reel assemblies. Therefore, it is intended that the novel teachings of the present invention not be limited to the particular embodiment disclosed, but that they will include all embodiments falling within the scope of the appended claims.

What is claimed is:

1. A retractable headphone assembly comprising:
a first wire having a first portion extending from a case, the first portion terminating at a male plug, and a second portion coiled about a first reel assembly, the reel assembly rotatably positioned within the case; and
a second wire having a first portion extending from the case, the first portion connected to at least one speaker, and a second portion coiled about a second reel assembly, the second reel assembly rotatably positioned within the case;
wherein said first reel assembly and said second reel assembly rotate independently from one another within the case about a common axis.

2. The headphone assembly of claim 1, wherein rotation of the first reel assembly causes the length of the first portion of the first wire to change.

3. The headphone assembly of claim 1, wherein each of the first reel assembly and the second reel assembly further comprise an inner flange, and wherein the inner flange of the first reel assembly is adjacent and parallel to the inner flange of the second reel assembly in a manner such that the inner flanges rotate about a common axis.

4. The headphone assembly of claim 3, wherein the first reel assembly further comprises an electrical spring contact positioned along the inner flange of the first reel assembly at a set radial distance from the common axis.

5. The headphone assembly of claim 4, wherein the second reel assembly further comprises a printed circuit board for positioning a ring along the inner flange of the second reel assembly such that the ring contacts the electrical spring contact as the first reel assembly rotates relative to the second reel assembly.

6. The headphone assembly of claim 1, wherein the second portion of the first wire maintains electrical connection with the second portion of the second wire as the first reel assembly and the second reel assembly rotate relative to one another.

7. The headphone assembly of claim 3, wherein the rotation of the first reel assembly is affected by pressure against an outer perimeter of the inner flange of the first reel assembly.

8. The headphone assembly of claim 1, wherein the first portion of the first wire comprises a microphone assembly.

9. The headphone assembly of claim 8, wherein the case forms a cavity for securing the microphone assembly.

10. A retractable wire assembly comprising:
a case;
at least one reel assembly rotatably positioned within the case, the reel assembly having at least one flange with a circular outer perimeter, and a spindle extending perpendicular to the center of the flange;
a wire having a first portion extending a distance from the case and a second portion coiled around the spindle; and
a lock assembly comprising:
a lever arm;
a one-way bearing assembly connected to the lever arm and comprising a rotatable outer cylinder; and
a torsion spring positioned to rotate the lever arm toward the outer perimeter of the at least one flange such that the rotatable outer cylinder of the one-way bearing assembly presses against said outer perimeter to affect the rotation of the at least one reel.

11. The retractable wire assembly of claim 10, wherein rotation of the at least one reel assembly causes the distance the first portion of the wire extends from the case to change.

12. The headphone assembly of claim 10, wherein the at least one reel assembly further comprises an inner flange, and wherein the inner flange of the at least one reel assembly is adjacent and parallel to an inner flange of a second reel assembly in a manner such that the inner flanges rotate about a common axis.

13. The headphone assembly of claim 12, wherein the at least one reel assembly further comprises an electrical spring contact positioned along the inner flange of the first reel assembly at a set radial distance from the common axis.

14. The headphone assembly of claim 13, wherein the second reel assembly further comprises a printed circuit board for positioning a ring along the inner flange of the second reel assembly such that the ring contacts the electrical spring contact as the at least one reel assembly rotates relative to the second reel assembly.

15. The headphone assembly of claim 1, wherein the first portion of the wire comprises a microphone assembly.

16. The headphone assembly of claim 15, wherein the case forms a cavity for securing the microphone assembly.
